(19) United States
(12) Patent Application Publication
(10) Pub. No.: US 2008/0264862 A1
(43) Pub. Date: Oct. 30, 2008

(54) Method for forming uneven perforations in membrane or film

(75) Inventors: Shia Chung Chen, Taoyuan Hsien (TW); Lei Ti Huang, Taiyuan Hsien (TW); Ping Shun Hsu, Taoyuan Hsien (TW)

Correspondence Address: CHARLES E. BAXLEY, ESQUIRE, 90 JOHN STREET, SUITE 309, NEW YORK, NY, 10038, US

(73) Assignee: Chung Yuan Christian University

(21) Appl. No.: 11/789,247

(22) Filed: Apr. 24, 2007

(51) Int. Cl. B01D 61/00

(52) U.S. Cl. 210/648

(57) ABSTRACT

A membrane treating or forming method includes a membrane having two opposite surfaces and a number of perforations formed in the membrane, an area closer to one of the surfaces of the membrane is cooled with such as a cool device, and an area closer to the other surface of the membrane is heated in order to distort and deform the perforations of the membrane and for forming uneven or distorted or deformed perforations in the membrane and thus for preventing the perforations of the membrane from being blocked by dirt or particles. A cold device is disposed in and spaced away from the heat device for forming an inner peripheral space between the heat device and the cold device and for receiving the membrane.

### BACKGROUND OF THE INVENTION

1. Field of the Invention

The present invention relates to a method, and more particularly to a method for treating a film or membrane and for forming uneven orifices or perforations in the film or membrane and for preventing the orifices or perforations of the film or membrane from being blocked by dirt or particles.

2. Description of the Prior Art

Typical filter devices may comprise one or more filtering films or membranes disposed therein for filtering water or fluid and for removing dirt or particles from the water or fluid.

For example, U.S. Pat. No. 4,935,143 to Kopp et al. discloses one of the typical filters comprise one or more hollow, porous, polymeric fibres or filtering films or membranes disposed therein for filtering water or fluid. Normally, the filtering films or membranes are made of polymeric materials or synthetic materials and each include a number of holes or orifices or perforations formed therein for water or fluid filtering purposes.

However, normally, the holes or orifices or perforations are uniformly formed in the films or membranes or include a uniform size or dimension or inner diameter such that the holes or orifices or perforations of the films or membranes may be easily blocked by dirt or particles.

U.S. Pat. No. 4,969,991 to Valadez discloses another typical water filtering or purifying and dispensing device and comprises one or more purification stages or mechanisms formed by activated carbon filters, ion exchange resin beds, reverse osmosis membrane filters, ultraviolet sterilizers and the like and provided for filtering water or fluid.

However, similarly, the holes or orifices or perforations are also uniformly formed in the films or membranes or purification stages or mechanisms, or include a uniform size or dimension or inner diameter for the holes or orifices or perforations such that the holes or orifices or perforations of the films or membranes may be easily blocked by dirt or particles.

The present invention has arisen to mitigate and/or obviate the afore-described disadvantages of the conventional filtering films or membranes.

### SUMMARY OF THE INVENTION

The primary objective of the present invention is to provide a method for treating a film or membrane and for forming uneven orifices or perforations in the film or membrane and for preventing the orifices or perforations of the film or membrane from being blocked by dirt or particles.

In accordance with one aspect of the invention, there is provided a method comprising providing a membrane which includes two opposite surfaces, and which includes a number of perforations formed in the membrane, cooling an area closer to a first surface of the surfaces of the membrane, and heating an area closer to a second surface of the surfaces of the membrane in order to distort and deform the perforations of the membrane and for forming uneven or distorted or deformed perforations in the film or membrane and for preventing the orifices or holes or perforations of the film or membrane from being blocked and damaged by dirt or particles.

A cold device is provided and disposed closer to the first surface of the membrane for cooling the area closer to the first surface of the membrane. The cold device includes a cylindrical container having a compartment formed therein for receiving a cold medium, and the membrane is disposed around the container. The membrane may be engaged around the container with at least one roller.

A heat device is provided and includes a chamber formed therein for receiving the cold device, and the cold device is preferably spaced away from the heat device for forming an inner peripheral space between the heat device and the cold device and for receiving the membrane. The membrane may be engaged and wound around a first spool and to be unwound and engaged onto a second spool.

The heat device includes a receptacle or housing for receiving the heat device, and the housing of the heat device is preferably and slidably engaged onto at least one rail for allowing the housing to be slid and moved along the rail. The housing of the heat device includes a temperature control device attached to the housing 31 and coupled to the heat device for actuating and controlling the heat device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a block diagram illustrating the processes for conducting a method in accordance with the present invention;

FIG. 2 is a partial cross sectional view illustrating one of the applications or arrangements or machines or facilities for conducting or operating the method;

FIG. 3 is an enlarged partial cross sectional view of the film or membrane treating machine or facility; and

FIG. 4 is a further enlarged partial cross sectional view illustrating the film or membrane treated or formed with the method in accordance with the present invention.

### DETAILED DESCRIPTION OF THE PREFERRED EMBODIMENT

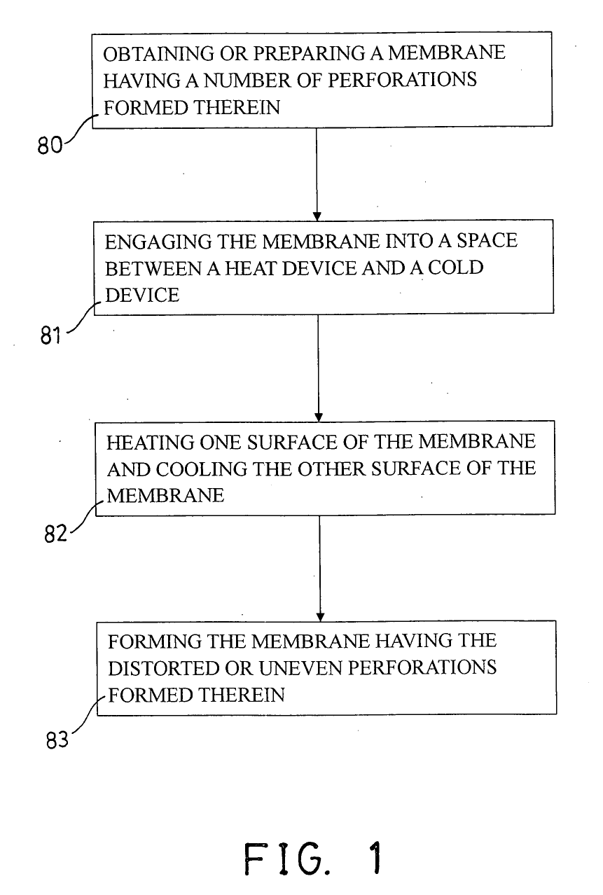

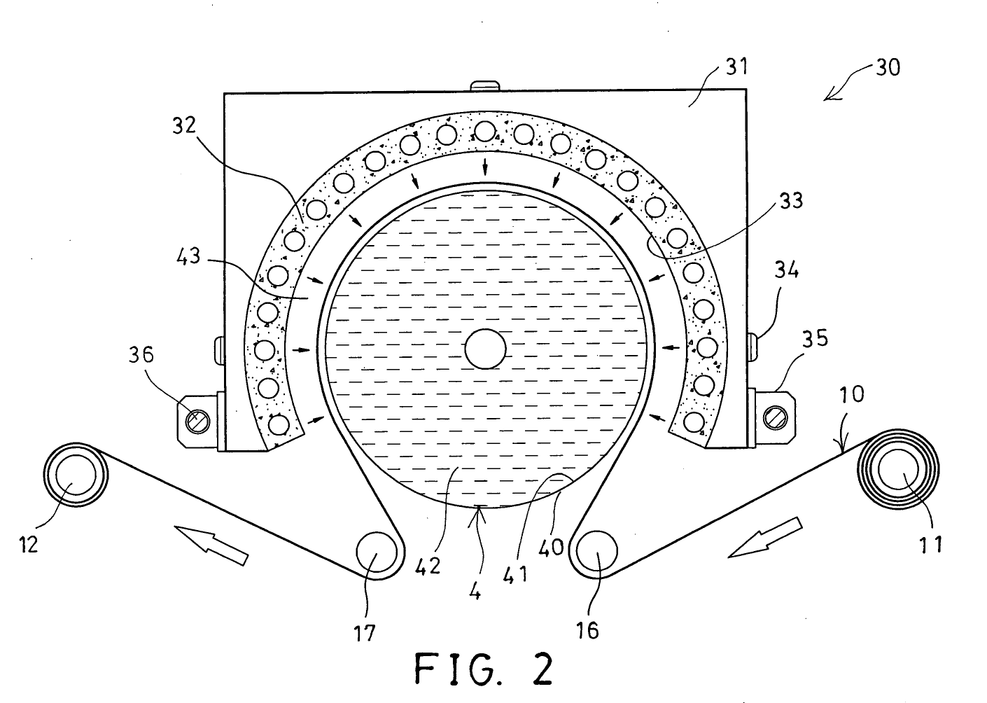

Referring to the drawings, and initially to FIGS. 1 and 2, a method in accordance with the present invention is provided for treating or forming or making a film or membrane 10 that may be provided for water or fluid filtering purposes, in which the film or membrane 10 may be engaged or wound around a spool 11 and to be unwound and sent or engaged onto the other spool 12, and the membrane 10 may include two outer or side or opposite surfaces 13, 14, and a number of holes or orifices or perforations 15 formed in the membrane 10 and/or formed between the opposite surfaces 13, 14 of the membrane 10, and the membrane 10 may be made of polymeric materials or other synthetic materials, such as the polytetra fluoro ethylene or Teflon, or other polymeric materials which may resist a great heat or temperature and which is corrosion resistive. Accordingly, a membrane 10 which includes a number of orifices or holes or perforations 15 formed in the membrane 10 is required to be prepared and provided in the process 80 as shown in FIG. 1.

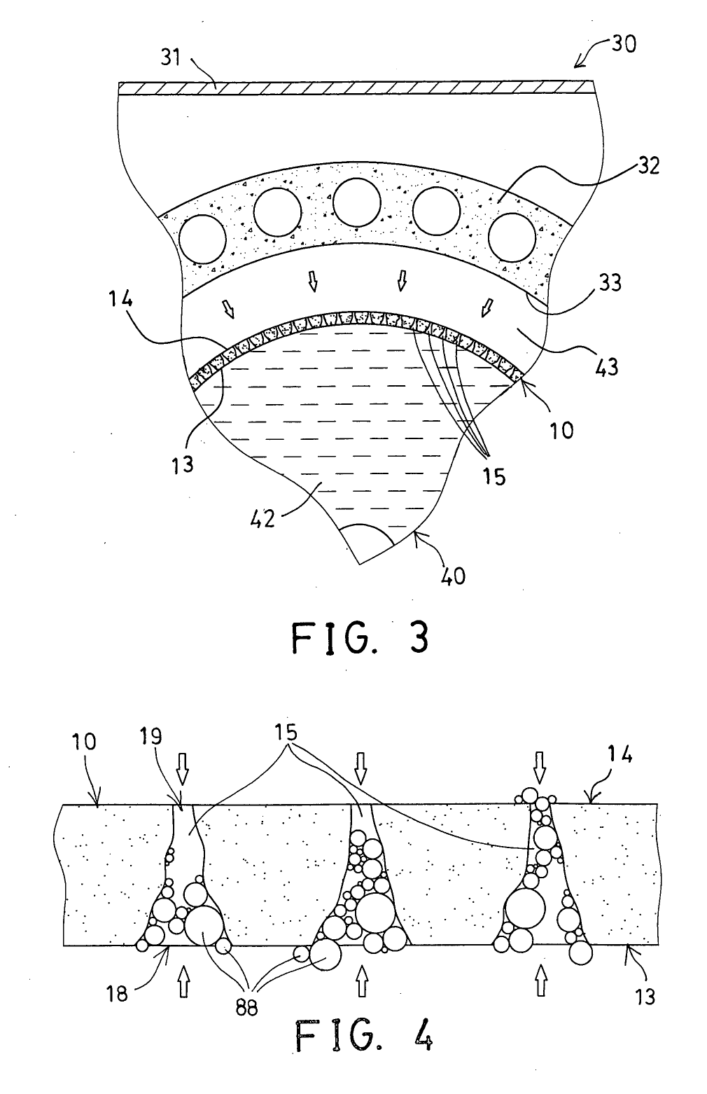

As shown in FIGS. 2 and 3, illustrated is a membrane treating machine or facility 30 and provided for treating the membrane 10 and for forming uneven orifices or perforations 15 in the membrane 10 and for preventing the orifices or perforations 15 of the membrane 10 from being blocked by dirt or particles. The membrane treating facility 30 comprises an outer receptacle or housing 31, a heat device 32 disposed in the housing 31 and including a rounded or substantially semi-cylindrical structure having a chamber 33 formed in the inner peripheral portion of the housing 31, and a temperature control device 34 attached to the housing 31 and coupled to the heat device 32 for actuating or controlling the heat device 32 to generate a heat medium, such as an ultrasonic wave, a supersonic wave, a laser ray or beam, an infrared ray, or the like.

The housing 31 may further include one or more (such as two) couplers 35 slidably engaged onto the rails 36 for allowing the housing 31 to be slid or moved along the rails 36, and the membrane treating facility 30 further comprises a cold device 4 disposed in the chamber 33 of the heat device 32 or the housing 31 and including a substantially cylindrical container 40 having a compartment 41 formed therein for receiving a cold medium 42, such as the water or other cold media, and the container 40 is disposed or arranged within the chamber 33 of the heat device 32 or the housing 31 and spaced away from the housing 31 for forming or defining an inner peripheral space 43 between the heat device 32 and the container 40 and for receiving the membrane 10.

As shown in FIGS. 2 and 3, the membrane 10 will be released or unwound from the spool 11 and to be engaged around one or more (such as two) rollers 16, 17, and to be engaged into or through the inner peripheral space 43 formed or defined between the heat device 32 and the container 40 of the cold device 4 in the process 81 as shown in FIG. 1, or to be engaged onto or around the container 40 of the cold device 4, and then to be engaged onto or received or wound on or around the other spool 12. The membrane 10 may be arranged and slightly spaced away from the container 40 of the cold device 4 (FIG. 2) or engaged onto the container 40 of the cold device 4 (FIG. 3) for allowing the cold device 4 to apply a low temperature to cool one of the surfaces 13 of the membrane 10, and for allowing the heat device 32 to apply a heat to heat the other or opposite surface 14 of the membrane 10 in the process 82 as shown in FIG. 1.

As shown in FIG. 4, the membrane 10 at the area closer to the one surface 13 may be shrunk, due to a cold or cool temperature, to form a wider opening 18 at one end of the perforations 15 of the membrane 10, and the membrane 10 at the area closer to the other surface 14 may be expanded or enlarged, due to a hotter or greater temperature, to form a narrower opening 19 at the other end of the perforations 15 of the membrane 10, and thus to form the distorted or uneven perforations 15 in the membrane 10 in the process 83 as shown in FIG. 1. The distorted or uneven perforations 15 of the membrane 10 may thus be used to filter the dirt or particles 88 (FIG. 4) of various or different diameters and for preventing the perforations 15 of the membrane 10 from being blocked by the dirt or particles 88.

It is to be noted that the two outer sides or opposite surfaces 13, 14 of the membrane 10 may be subjected or suffered with different temperatures, or may have the area closer to one surface 14 expanded or enlarged by the heat and may have the area closer to the other surface 13 distorted or shrunk by the cold or cool temperature, in order to distort or deform the perforations 15 of the membrane 10 and thus to form the distorted or uneven or deformed perforations 15 in the membrane 10. The housing 31 and the heat device 32 may be moved along the rails 36 and relative to the cold device 4 in order to selectively engaged onto the container 40 of the cold device 4 when it is required to apply the heat onto the area closer to the surface 14 of the membrane 10. The housing 31 and the heat device 32 may also be moved away from the cold device 4 when required.

The membrane 10 may be arranged and supported the container 40 and/or slightly spaced away from the container 40 of the cold device 4 (FIG. 2) by one or more further rollers or wheels (not shown) or the like for suitably spacing the membrane 10 from the container 40 of the cold device 4 and for allowing the cold device 4 to suitably apply the low temperature to cool one of the surfaces 13 of the membrane 10, and the temperature control device 34 may be coupled to the heat device 32 for actuating or controlling the heat device 32 to generate a heat of a suitable or a predetermined temperature and to heat the other surface 14 of the membrane 10 and thus to form the distorted or uneven or deformed perforations 15 in the membrane 10.

Accordingly, the method in accordance with the present invention may be provided for treating a film or membrane and for forming uneven orifices or perforations in the film or membrane and for preventing the orifices or perforations of the film or membrane from being blocked by dirt or particles.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method comprising:
providing a membrane which includes two opposite surfaces, and which includes a plurality of perforations formed in said membrane,
cooling an area closer to a first surface of said surfaces of said membrane, and
heating an area closer to a second surface of said surfaces of said membrane in order to distort and deform said perforations of said membrane.

2. The method as claimed in claim 1, wherein a cold device is disposed closer to said first surface of said membrane for cooling the area closer to said first surface of said membrane.

3. The method as claimed in claim 2, wherein said cold device includes a cylindrical container having a compartment formed therein for receiving a cold medium, and said membrane is disposed around said container.

4. The method as claimed in claim 3, wherein said membrane is engaged around said container with at least one roller.

5. The method as claimed in claim 2, wherein a heat device includes a chamber formed therein for receiving said cold device, and said cold device is spaced away from said heat device for forming an inner peripheral space between said heat device and said cold device and for receiving said membrane.

6. The method as claimed in claim 5, wherein said heat device includes a housing for receiving said heat device.

7. The method as claimed in claim 6, wherein said housing of said heat device is slidably engaged onto at least one rail for allowing said housing to be slid and moved along said at least one rail.

8. The method as claimed in claim 6, wherein said housing of said heat device includes a temperature control device attached to said housing 31 and coupled to said heat device for actuating and controlling said heat device.

9. The method as claimed in claim 1, wherein said membrane is engaged and wound around a first spool and to be unwound and engaged onto a second spool.
